(19) United States
(12) Patent Application Publication
(10) Pub. No.: US 2021/0163170 A1
(43) Pub. Date: Jun. 3, 2021

(54) FOLDABLE PAPER CONTAINER FOR COOKING

(71) Applicant: NEURU CO.,LTD., Siheung-si, Gyeonggi-do (KR)

(72) Inventor: Jae Il KIM, Ansan-si (KR)

(73) Assignee: NEURU CO.,LTD., Siheung-si, Gyeonggi-do (KR)

(21) Appl. No.: 17/046,745

(22) PCT Filed: Dec. 17, 2018
(86) PCT No.: PCT/KR2018/016025

§ 371 Date: Oct. 9, 2020

(30) Foreign Application Priority Data
Apr. 9, 2018 (KR) 20-2018-0001555

(51) Int. Cl. B65D 5/36; B65D 5/56; B65D 5/46; B65D 81/34; A47J 36/04; A47J 36/02

(52) U.S. Cl. CPC B65D 5/3657; B65D 5/563; B65D 5/4612; B65D 2581/3404; A47J 36/04; A47J 36/022; B65D 81/3415

(57) ABSTRACT

The present invention relates to a foldable paper container for cooking and, more particularly, to a foldable paper container for cooking in which the paper can easily be folded and used as a container. The foldable paper container for cooking, of the present invention, is configured such that when forming a container by folding, fixing portions that connect side wall portions and connection portions are folded in directions opposite to protruding directions such that the side wall portions and the connection portions maintain a folded state.

### TECHNICAL FIELD

The present invention relates to a foldable paper container for cooking, and more particularly, to a foldable paper container for cooking so as to be used as a container by easily folding paper.

### BACKGROUND ART

As the need for enjoying nature is gradually growing due to the urbanized society and the busier life, outdoor populations going out to suburbs during leisure time and participating in outdoor activities are increasing.

In response to the increasing outdoor populations, various types of outdoor products have been released. Among the outdoor products, various types of cooking containers for cooking food outdoors have been produced.

The use of disposable cooking containers among the cooking containers is gradually increasing. Since the disposable cooking container is mainly formed of paper thereby having a light weight, and since the disposable cooking container is disposable, cleaning is unnecessary, which is very convenient.

The disposable cooking container may be classified into a non-folding cooking container and a folding paper container.

The non-folding cooking container has a structure that cannot be folded and typically includes a cup noodle container.

In addition, the folding cooking container has a foldable structure for reducing the volume when carried or stored, and configured such that a folded wall is unfolded and erected, and food such as soup or broth is put therein to boil the food by heating the food using a gas range or the like.

However, according to the conventional folding cooking container, since the structure is complicated, consumers have difficulties to fold the cooking container for themselves.

### DISCLOSURE

### Technical Problem

To solve the above problems, an object of the present invention is to provide a foldable paper container for cooking, which has a simple structure to enable a consumer to fold and use the paper container.

### Technical Solution

To solve the above object, the foldable paper container for cooking of the present invention includes: a bottom surface portion having a quadrangular shape; four side wall portions having one ends connected to edge portions of the bottom surface portion and opposite ends extending in outward directions, respectively, in which the opposite ends are bent with respect to the edge portions; connection portions each connecting side ends of the side wall portions arranged adjacent to each other, formed with a first bending line between the connection portion and the side end of the side wall portion, and formed therein with a second bending line in a diagonal direction from a vertex of the bottom surface portion; and a plurality of fixing portions configured to maintain a fixed state of the container such that the container is prevented from being deployed when the container is formed by bending the side wall portions and the connection portions, wherein the first side wall portion and the second side wall portion among the four side wall portions are arranged to face each other, the third side wall portion and the fourth side wall portion are arranged to face each other, an outer end of the connection portion is continuously connected to the opposite end of the side wall portion, one of the fixing portions protrudes in a direction toward the first bending line while connecting the opposite end of the side wall portion with the outer end of the connection portion, and the fixing portion connecting the side wall portion and the connection portion to each other is bent in a direction opposite to the protruding direction when the container is formed by bending, such that the side wall portion and the connection portion are maintained in a bent state.

One of the fixing portions may be bent while simultaneously covering outer surfaces of the two adjacent side wall portions in directions of the outer surfaces of the two adjacent side wall portions, such that the side wall portion and the connection portion are maintained in a bent state.

The fixing portion may be bent in the direction of the outer surface of the side wall portion while covering an outer portion of the connection portion which is self-folded.

Two third bending lines may be formed in diagonal directions at each of the third side wall portion and the fourth side wall portion, in which the two third bending lines may have one ends connected to vertexes of the bottom surface portion and opposite ends connected to each other, thereby forming a triangular shape together with the edge portion of the bottom surface portion, and the fixing portion is bent at an angle of 180 degrees in a direction toward the outer surface of the side wall portions arranged adjacently in a state in which the first side wall portion, the second side wall portion, and the connection portions are folded inward, and the connection portions, the third side wall portion, and the fourth side wall portion are bent inward along the second bending lines and the third bending lines.

The fixing portion may protrude with a largest length in the direction of the first bending line.

Handle portions may protrude from the opposite ends of the first side wall portion and the second side wall portion, respectively.

The connection portions may be bent to come into close contact with the third side wall portion and the fourth side wall portion, and the second bending line and the third bending line are arranged at a same position with each other.

A bending prevention protrusion bent in an outward direction may be formed and incised at a portion where the opposite ends of the two third bending lines are connected to each other in the third side wall portion and the fourth side wall portion.

After the container is formed by bending, the third side wall portion and the fourth side wall portion may be bent by pushing the third side wall portion and the fourth side wall portion in a direction toward the bottom surface portion based on the third bending line, in which the third side wall portion and the fourth side wall portion may be folded based on the third bending lines, respectively, and the connection portions and the first side wall portion, and the connection portions and the second side wall portion may be stacked on upper portions of the third side wall portion and the fourth side wall portion, so that the first side wall portion and the second side wall portion are folded to face the bottom surface portion.

### Advantageous Effects

According to the foldable paper container for cooking of the present invention as described above, the advantageous effects are as follows.

The simple structure can enable the consumer to easily and quickly fold and use the paper container.

In particular, the fixing portion prevents the folded paper container from being arbitrarily unfolded, so that a shape of the folded paper container can be maintained without any change.

### DESCRIPTION OF DRAWINGS

FIG. 1 is a development view of a foldable paper container for cooking according to an embodiment of the present invention.

FIG. 2 shows plan views illustrating folding processes of the foldable paper container for cooking according to the embodiment of the present invention.

FIG. 3 is a perspective view of a state in which side wall portions in FIG. 2 are partially erected.

FIG. 4 is a perspective view of a state in which the side wall portions in FIG. 3 are completely erected.

FIG. 5 is a perspective view of a completed state of the paper container by bending a bending prevention protrusion in FIG. 4.

FIG. 6 is a perspective view showing a process of folding the foldable paper container for cooking according to the embodiment of the present invention to have a compact size.

FIG. 7 is a perspective view showing a completed state by folding the foldable paper container for cooking in FIG. 6 to have the compact size.

### BEST MODE

A foldable paper container for cooking of the present invention has a hexahedral shape in which an outer side is formed of paper and an inner surface is formed of a metal sheet.

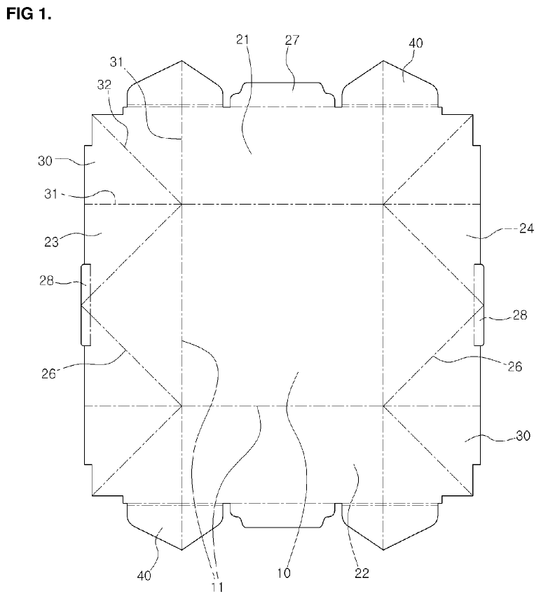

As shown in FIGS. 1 to 5, the foldable paper container for cooking according to the present invention includes a bottom surface portion 10, side wall portions 21, 22, 23, and 24, connection portions 30, and fixing portions 40.

When the paper container is deployed, all of the bottom surface portion 10, the side wall portions 21, 22, 23, and 24, the connection portions 30, and the fixing portions 40 are connected together on the same plane, and represent corresponding positions and areas.

The bottom surface portion 10 is positioned in the middle of the paper container, and have a quadrangular shape.

The side wall portions 21, 22, 23, and 24 have one ends connected to edge portions 11 of the bottom surface portion 10 and the other ends extending outwardly, respectively, in which the other ends are bent with respect to the edge portions 11.

Since the side wall portions 21, 22, 23, and 24 are connected at the edge portions 11 of the bottom surface portion 10, the number of the side wall portions is four.

More specifically, among the four side wall portions 21, 22, 23, and 24, the first side wall portion 21 and the second side wall portion 22 are arranged to face each other, and the third side wall portion 23 and the fourth side wall portion 24 are arranged to face each other.

The side wall portion is formed in a substantially quadrangular shape, but may be formed in a shape other than the quadrangular shape, in which, for example, the other end protruding outward may be have a curved shape.

The connection portion 30 includes four connection portions to connect side ends of adjacent side wall portions to each other.

An outer end of the connection portion 30 is continuously connected to the other end of the side wall portion.

A first bending line 31 is formed between the connection portion 30 and the side end of the side wall portion, and a second bending line 32 is formed inside the connection portion in a diagonal direction from a vertex of the bottom surface portion 10.

The connection portion 30 and the side wall portion are bent around the first bending line 31, and the connection portion 30 itself is bent around the second bending line 32.

When the container is formed by bending the side wall portions and the connection portions 30, the fixing portion 40 is configured to maintain a fixed state to prevent the container from being deployed.

According to the present invention, the total number of the fixing portion 40 is four, and one of the fixing portion 40 protrudes in a direction forming the first bending line 31 while connecting the other end of the side wall portion with an outer end of the connection portion 30.

When the container is formed by bending, the fixing portion 40 connecting the side wall portion and the connection portion 30 to each other is bent in a direction opposite to the protruding direction, such that the side wall portion and the connection portion 30 are maintained in a bent state.

More specifically, the fixing portion 40 is bent while simultaneously covering the two adjacent side wall portions in directions toward outer surfaces of two adjacent side wall portions, such that the side wall portion and the connection portion 30 are maintained in a bent state.

The fixing portion 40 is bent in the direction of the outer surface of the side wall portion while covering an outer portion of the connection portion 30 self-folded along the second bending line 32.

The fixing portion 40 connecting the side wall portion and the connection portion 30 to each other is bent in the outward direction as described above, so that the folded sidewall portion and the folded connection portion 30 may be prevented from being deployed.

The fixed portion 40 may have the same protruding length, and may protrude most in the direction of forming the first bending line 31.

The fixing portion 40 has a shape to protrude most in the direction of forming the first bending line 31, such that the bent fixing portion 40 may more firmly prevent the side wall portion and the connection portion 30 from being deployed.

Handle portions 27 protrude from the other ends of the first side wall portion 21 and the second side wall portion 22 facing each other, respectively.

In addition, two third bending lines 26 are formed in diagonal directions at each of the third side wall portion 23 and the fourth side wall portion 24 facing each other.

The two third bending lines 26 have one ends connected to vertexes of the bottom surface portion 10 and the other ends connected to each other, thereby forming a triangular shape together with the edge portion 11 of the bottom surface portion 10.

In a state in which the first side wall portion 21, the second side wall portion 22, and the connection portions 30 are folded inward, and the connection portions 30, the third side wall portion 23, and the fourth side wall portion 24 are bent inward along the second bending lines 32 and the third bending lines 26, the fixing portion 40 is bent at an angle of 180 degrees in the direction of the outer surface of the side wall portions arranged adjacently.

Accordingly, the side wall portions and the connection portions 30 adjacent to each other may be prevented from being arbitrarily deployed.

The connection portions 30 are bent and then come into close contact with the third side wall portion 23 and the fourth side wall portion 24 in which the third bending lines 26 are formed, and the second bending line 32 and the third bending line 26 are arranged at the same position with each other.

A bending prevention protrusion 28 bent in an outward direction is formed and incised at a portion where the other ends of the two third bending lines 26 are connected to each other, in each of the third side wall portion 23 and the fourth side wall portion 24 formed with the third bending lines 26.

The above bending prevention protrusions 28 are bent in the outward direction, so that the third side wall portion 23 and the fourth side wall portion 24 may be prevented from being arbitrarily bent by the third bending lines 26, and accordingly the stiffness of the side wall portion may be increased.

Hereinafter, a folding process according to the above configuration of the present invention will be described.

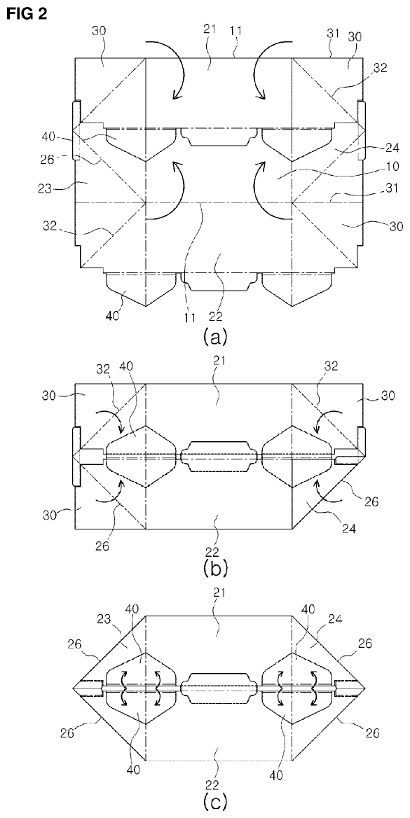

In a state in which all components are deployed as shown in FIG. 1, the first side wall portion 21 and the second side wall portion 22 are folded inward as shown in FIG. 2(a).

The connection portions 30 connected to the first side wall portion 21 and the second side wall portion 22 are also folded together.

The first side wall portion 21 and the second side wall portion 22 are folded around the edge portions 11, and the connection portion 30 is folded around the first bending lines 31.

At this time, the second bending line 32 and the third bending line 26 are arranged at the same position with each other.

Then, as shown in FIG. 2(b), the connection portions 30 and the third side wall portion 23 overlapping each other are folded inward around the second bending line 32 and the third bending line 26, and the connection portions 30 and the fourth side wall portion 24 overlapping each other are folded inward around the second bending line 32 and the third bending line 26.

After the connection portions 30, the third side wall portion 23 and the fourth side wall portion 24 are folded, the fixing portion 40 is bent in the outward direction as shown in FIG. 2(c).

The fixing portion 40 is bent at an angle of 180 degrees in the direction of the outer surface of the side wall portion while covering the outer end of the connection portion 30.

In other words, as shown in FIG. 2(b), the fixing portion 40 is bent at the angle of 180 degrees while covering outer surfaces of the two adjacently arranged side wall portions in directions toward outer surfaces of the side wall portions by bending.

In other words, the four fixing portions 40 are bent outward while covering the first side wall portion 21 and the third side wall portion 23, the first side wall portion 21 and the fourth side wall portion 24, the second side wall portion 22 and the third side wall portion 23, and the second side wall portion 22 and the fourth side wall portion 24.

When the fixing portion 40 is bent in the direction of the outer surface of the side wall portion, the fixing portion 40 is bent in the direction of the outer surface of the side wall portion while covering the outer side portion of the connection portion 30 self-folded through the second bending line 32.

In addition, since the fixing portion 40 protruding to the outside is just folded at the angle of 180 degrees in a state where the connection portions 30, the third side wall portion 23 and the fourth side wall portion 24 are folded, the fixing portion 40 is easily folded.

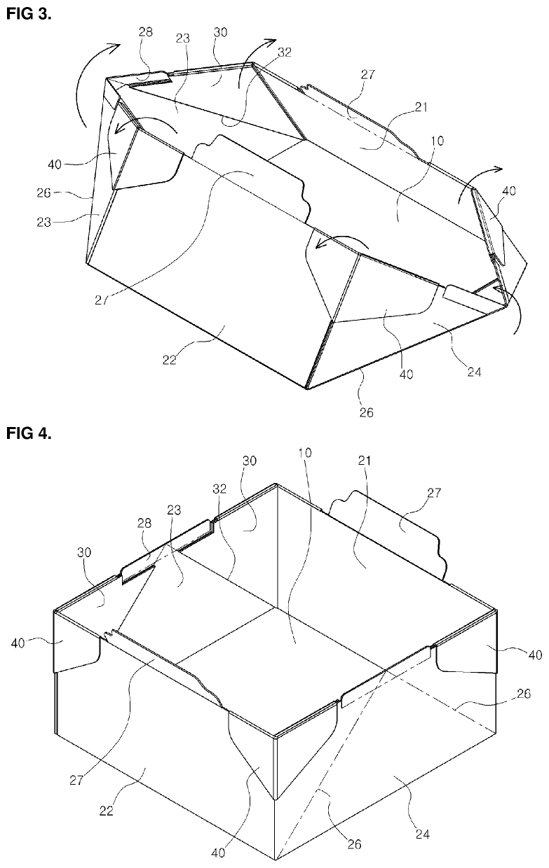

Then, as shown in FIG. 3, the first side wall portion 21 and the second side wall portion 22 folded inward are held and erected.

When the first side wall portion 21 and the second side wall portion 22 are held and erected, the third side wall portion 23 and the fourth side wall portion 24 are also erected as shown in FIG. 4, so that the paper container is formed in a hexahedral shape.

The fixing portion 40 covers the outer surfaces of two side wall portions arranged adjacently at an angle of 90 degrees, thereby preventing the folded connection portion 30 from being deployed.

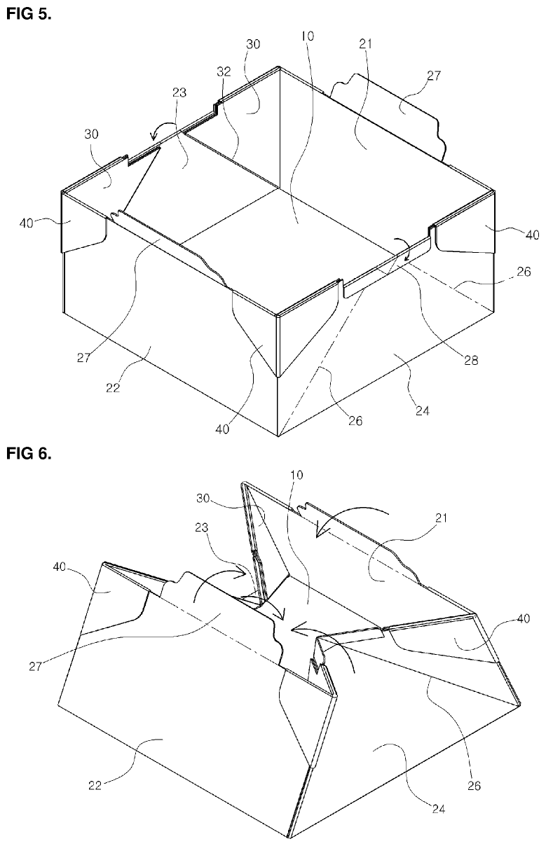

Then, as shown in FIG. 5 the bending prevention protrusions 28 formed in the third side wall portion 23 and the fourth side wall portion 24 are bent outward, so that the paper container may be maintained in the hexahedral shape with a sturdy state to prevent the third side wall portion 23 and the fourth side wall portion 24 from collapsing by the third bending line 26.

When the paper container is completed, the paper container may be heated using heat after food such as an instance noodle is put therein.

Thus, according to the present invention, the paper container can be formed after simply folded and the formed paper container can be kept in a solid state.

In addition, since the connection portions 30 are folded and the fixing portions 40 are fixed, even the broth inside the paper container can be prevented from being leaked to the outside.

Meanwhile, according to the present invention, the paper container may be provided to the consumer in an entirely deployed state as shown in FIG. 1, but may be preferably provided to the consumer in a state as shown in FIG. 2 (c) to reduce a convenience and a volume in use.

When the paper container is provided to the user in the folded state as shown in FIG. 2(c), the user may quickly and easily form the paper container sequentially as shown in FIGS. 3 to 5, thereby facilitating the convenience in use.

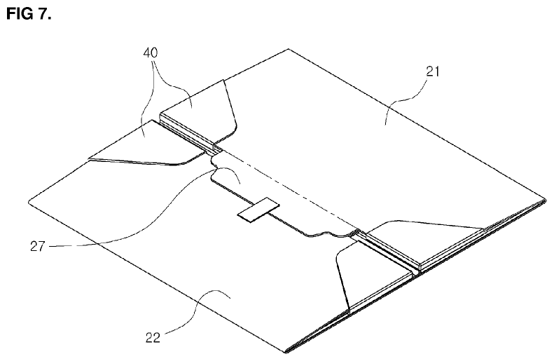

In addition, the paper container may be provided to the consumer while being folded in a state as shown in FIGS. 6 and 7.

The above process will be described in detail. First, after the paper container is formed as shown in FIG. 4, the third side wall portion 23 and the fourth side wall portion 24 are pushed and bent in the direction of the bottom surface portion 10 around the third bending line 26 as shown in FIG. 6.

The third side wall portion 23 and the fourth side wall portion 24 are folded around the third bending lines 26, respectively. The connection portions 30 and the first side wall portion 21, and the connection portions 30 and the second side wall portion 32 are stacked on the third side wall portion 23 and the fourth side wall portion 24, so that the first side wall portion 21 and the second side wall portion 22 are folded to face the bottom surface portion 10.

Accordingly, as shown in FIG. 7, the bottom surface portion 10 is arranged at a lower part, the first side wall portion 21 and the second side wall portion 22 are arranged at an upper part, and the connection portions 30, the third side wall portion 23 and the fourth side wall portion 24 are arranged inside so as to be folded in a quadrangular shape the same as the bottom surface portion 10 without being exposed, so that a size can be reduced.

In the case intended to form the paper container from the above state, the paper container may be in the state as shown in FIG. 4 when the first side wall portion 21 and the second side wall portion 22 are held and erected. Then, as shown in FIG. 5, the bending prevention protrusions 28 are bent, thereby completing the formation of the paper container.

The foldable paper container for cooking of the present invention is not limited to the above-described embodiments, and various modifications can be made within the allowable scope of the technical idea of the present invention.

### INDUSTRIAL APPLICABILITY

The present invention has the industrial applicability to be applied to paper containers for cooking for boiling an instance noodle and the like.

1. A foldable paper container for cooking having a hexahedral shape and including an outer side formed of paper and an inner surface formed of a metal sheet, the foldable paper container comprising:
a bottom surface portion having a quadrangular shape;
four side wall portions having one ends connected to edge portions of the bottom surface portion and opposite ends extending in outward directions, respectively, in which the opposite ends are bent with respect to the edge portions;
connection portions each connecting side ends of the side wall portions arranged adjacent to each other,
formed with a first bending line between the connection portion and the side end of the side wall portion, and
formed therein with a second bending line in a diagonal direction from a vertex of the bottom surface portion; and
a plurality of fixing portions configured to maintain a fixed state of the container such that the container is prevented from being deployed when the container is formed by bending the side wall portions and the connection portions, wherein
the first side wall portion and the second side wall portion among the four side wall portions are arranged to face each other, the third side wall portion and the fourth side wall portion are arranged to face each other, an outer end of the connection portion is continuously connected to the opposite end of the side wall portion, one of the fixing portions protrudes in a direction toward the first bending line while connecting the opposite end of the side wall portion with the outer end of the connection portion, and the fixing portion connecting the side wall portion and the connection portion to each other is bent in a direction opposite to the protruding direction when the container is formed by bending, such that the side wall portion and the connection portion are maintained in a bent state.

2. The foldable paper container of claim 1, wherein one of the fixing portions is bent while simultaneously covering outer surfaces of the two adjacent side wall portions in directions toward the outer surfaces of the two adjacent side wall portions, such that the side wall portion and the connection portion are maintained in a bent state.

3. The foldable paper container of claim 2, wherein the fixing portion is bent in the direction toward the outer surface of the side wall portion while covering an outer portion of the connection portion which is self-folded.

4. The foldable paper container of claim 3, wherein two third bending lines are formed in diagonal directions at each of the third side wall portion and the fourth side wall portion, in which the two third bending lines have one ends connected to vertexes of the bottom surface portion and opposite ends connected to each other, thereby forming a triangular shape together with the edge portion of the bottom surface portion, and the fixing portion is bent at an angle of 180 degrees in a direction toward the outer surface of the side wall portions arranged adjacently in a state in which the first side wall portion, the second side wall portion, and the connection portions are folded inward, and the connection portions, the third side wall portion, and the fourth side wall portion are bent inward along the second bending lines and the third bending lines.

5. The foldable paper container of claim 1, wherein the fixing portion protrudes with a largest length in the direction of the first bending line.

6. The foldable paper container of claim 1, wherein handle portions protrude from the opposite ends of the first side wall portion and the second side wall portion, respectively.

7. The foldable paper container of claim 4, wherein the connection portions are bent to come into close contact with the third side wall portion and the fourth side wall portion, and the second bending line and the third bending line are arranged at a same position with each other.

8. The foldable paper container of claim 4, wherein a bending prevention protrusion bent in an outward direction is formed and incised at a portion where the opposite ends of the two third bending lines are connected to each other in the third side wall portion and the fourth side wall portion.

9. The foldable paper container of claim 4, wherein, after the container is formed by bending, the third side wall portion and the fourth side wall portion are bent by pushing the third side wall portion and the fourth side wall portion in a direction toward the bottom surface portion based on the third bending line, in which the third side wall portion and the fourth side wall portion are folded based on the third bending lines, respectively, and the connection portions and the first side wall portion, and the connection portions and the second side wall portion are stacked on upper portions of the third side wall portion and the fourth side wall portion, so that the first side wall portion and the second side wall portion are folded to face the bottom surface portion.
